(19) United States
(12) Patent Application Publication
(10) Pub. No.: US 2021/0279589 A1
(43) Pub. Date: Sep. 9, 2021

(54) ELECTRONIC DEVICE AND CONTROL METHOD THEREOF

(71) Applicant: SAMSUNG ELECTRONICS CO., LTD., Gyeonggi-do (KR)

(72) Inventors: Dongsoo LEE, Gyeonggi-do (KR); Parichay KAPOOR, Gyeonggi-do (KR); Byeoungwook KIM, Gyeonggi-do (KR)

(21) Appl. No.: 17/258,617

(22) PCT Filed: May 10, 2019
(86) PCT No.: PCT/KR2019/005603

§ 371 Date: Jan. 7, 2021

(30) Foreign Application Priority Data
Aug. 28, 2018 (KR) 10-2018-0101592

(51) Int. Cl. G06N 3/08; G06K 9/62

(52) U.S. Cl. CPC G06N 3/082; G06K 9/6288; G06K 9/6261

(57) ABSTRACT

Disclosed is an electronic device. The electronic device comprises a storage in which sample data and a matrix included in an artificial intelligence model which is trained on the basis of the sample data are stored, and a processor, wherein the processor is configured to: on the basis of the sizes of a plurality of elements included in the matrix, obtain a first matrix pruned by converting values of elements in the number corresponding to a first proportion to zero values; on the basis of test data, obtain first accuracy of an artificial intelligence model including the first matrix; if the first accuracy is within a preset range with respect to a preset value, retrain the artificial intelligence model including the first matrix on the basis of the sample data; and, on the basis of the sizes of a plurality of elements included in the retrained first matrix, obtain a second matrix pruned by converting values of elements in the number corresponding to a second proportion, which is greater than the first proportion, to zero values.

### TECHNICAL FIELD

The disclosure relates to an electronic device for compressing an artificial intelligence model and a control method thereof in an artificial intelligence (AI) system simulating functions of a human brain such as cognition and determination by using a machine learning algorithm such as deep learning and applications thereof, and more particularly, to an electronic device for compressing an artificial intelligence model while maintaining accuracy, and a control method thereof.

### DESCRIPTION OF THE RELATED ART

Recently, artificial intelligence systems implementing intelligence of a human level are used in various fields. An artificial intelligence system refers to a system wherein a machine learns, determines, and becomes smarter by itself, unlike conventional rule-based smart systems. An artificial intelligence system shows a more improved recognition rate as it is used more, and becomes capable of understanding user preference more correctly. For this reason, conventional rule-based smart systems are gradually being replaced by deep learning-based artificial intelligence systems.

An artificial intelligence technology consists of machine learning (for example, deep learning) and element technologies utilizing machine learning.

Machine learning refers to an algorithm technology of classifying/learning the characteristics of input data by itself, and an element technology refers to a technology of simulating functions of a human brain such as cognition and determination by using a machine learning algorithm such as deep learning, and includes fields of technologies such as linguistic understanding, visual understanding, inference/prediction, knowledge representation, and operation control.

Examples of various fields to which artificial intelligence technologies are applied are as follows. Linguistic understanding refers to a technology of recognizing languages/characters of humans, and applying/processing them, and includes natural speech processing, machine translation, communication systems, queries and answers, voice recognition/synthesis, and the like. Visual understanding refers to a technology of recognizing an object in a similar manner to human vision, and processing the object, and includes recognition of an object, tracking of an object, search of an image, recognition of humans, understanding of a scene, understanding of a space, improvement of an image, and the like. Inference/prediction refers to a technology of determining information and then making logical inference and prediction, and includes knowledge/probability based inference, optimization prediction, preference based planning, recommendation, and the like. Knowledge representation refers to a technology of automatically processing information of human experiences into knowledge data, and includes knowledge construction (data generation/classification), knowledge management (data utilization), and the like. Operation control refers to a technology of controlling autonomous driving of vehicles and movements of robots, and includes movement control (navigation, collision, driving), operation control (behavior control), and the like.

Meanwhile, there is a problem that, when accuracy increases linearly in an artificial intelligence model, data capacity increases exponentially. As methods for overcoming this problem, model compression based on pruning and low-rank factorization, and the like are being suggested.

Pruning is a method of removing redundant weights, but in the conventional technology, there was a problem that a pruning rate for maintaining accuracy was very low, or a substantial amount of operation was required for calculating a higher pruning rate, and thus commercialization of a product was difficult.

Model compression based on low-rank factorization is a method of dividing matrices in an m×n number into two matrices having a rank r, and for example, matrices in an m×n number may be divided into a form of (m×r)×(r×n). In this case, there is a problem that, even though the entire matrix size can be reduced if r is smaller than m or n, accuracy decreases. Also, there is a problem that a compression rate is practically not meaningful.

Accordingly, a method for reducing data capacity meaningfully while maintaining accuracy to a specific level through a simpler means is needed.

### DETAILED DESCRIPTION OF THE INVENTION

### Technical Problem

The disclosure is for addressing the aforementioned need, and the purpose of the disclosure is in providing an electronic device that is capable of reducing the data capacity of an artificial intelligence model while maintaining accuracy, and a control method thereof.

### Technical Solution

An electronic device according to an embodiment of the disclosure for achieving the aforementioned purpose includes a storage in which sample data and a matrix included in an artificial intelligence model which is trained based on the sample data are stored, and a processor configured to, based on sizes of a plurality of elements included in the matrix, obtain a first matrix pruned by converting values of elements in the number corresponding to a first proportion to zero values, and based on test data, obtain first accuracy of an artificial intelligence model including the first matrix, and based on the first accuracy being within a preset range with respect to a preset value, retrain the artificial intelligence model including the first matrix based on the sample data, and based on sizes of a plurality of elements included in the retrained first matrix, obtain a second matrix pruned by converting values of elements in the number corresponding to a second proportion, which is greater than the first proportion, to zero values.

Here, the processor may identify elements in the number corresponding to the first proportion in the order of having smaller sizes of absolute values among the plurality of elements included in the matrix, and identify elements in the number corresponding to the second proportion in the order of having smaller sizes of absolute values among the plurality of elements included in the retrained first matrix.

Meanwhile, the processor may obtain second accuracy of an artificial intelligence model including the second matrix based on the test data, and based on the second accuracy being within the preset range with respect to the preset value, retrain the artificial intelligence model including the second matrix based on the sample data, and based on sizes of a plurality of elements included in the retrained second matrix, obtain a third matrix pruned by converting values of elements in the number corresponding to a third proportion, which is greater than the second proportion, to zero values.

Here, the processor may obtain third accuracy of an artificial intelligence model including the third matrix based on the test data, and based on the third accuracy being outside the preset range with respect to the preset value, determine the second matrix as the final matrix of the matrix included in the artificial intelligence model.

Alternatively, the processor may, based on the number of times of pruning applied to the third matrix being a preset number of times, determine the third matrix as the final matrix of the matrix included in the artificial intelligence model.

Meanwhile, the processor may, based on the first accuracy being outside the preset range with respect to the preset value, convert values of elements in the number corresponding to a proportion smaller than the first proportion to zero values, based on the sizes of a plurality of elements included in the matrix, so as to obtain a re-pruned first matrix.

Also, the preset value may be obtained based on the accuracy of the artificial intelligence model including the matrix based on the test data.

Meanwhile, the processor may divide the matrix into a first sub matrix and a second sub matrix through singular value decomposition (SVD) based on a first rank value, instead of a pruning operation based on the first proportion, and combine the first sub matrix and the second sub matrix to obtain the first matrix. Also, the processor may divide the retrained first matrix into a third sub matrix and a fourth sub matrix through SVD based on a second rank value smaller than the first rank value, instead of a pruning operation based on the second proportion, and combine the third sub matrix and the fourth sub matrix to obtain the second matrix.

Here, the processor may obtain second accuracy of an artificial intelligence model including the second matrix based on the test data, and based on the second accuracy being outside the preset range with respect to the preset value, determine the first sub matrix and the second sub matrix as the final matrices of the matrix included in the artificial intelligence model.

Also, the processor may, based on the first accuracy being outside the preset range with respect to the preset value, redivide the matrix into the first sub matrix and the second sub matrix through SVD based on a second rank value bigger than the first rank value, and combine the first sub matrix and the second sub matrix to reobtain the first matrix.

Meanwhile, a control method of an electronic device storing sample data and a matrix included in an artificial intelligence model which is trained based on the sample data according to an embodiment of the disclosure includes the steps of, based on sizes of a plurality of elements included in the matrix, obtaining a first matrix pruned by converting values of elements in the number corresponding to a first proportion to zero values, and based on test data, obtaining first accuracy of an artificial intelligence model including the first matrix, and based on the first accuracy being within a preset range with respect to a preset value, retraining the artificial intelligence model including the first matrix based on the sample data, and based on sizes of a plurality of elements included in the retrained first matrix, obtaining a second matrix pruned by converting values of elements in the number corresponding to a second proportion, which is greater than the first proportion, to zero values.

Here, in the step of acquiring a first matrix, elements in the number corresponding to the first proportion may be identified in the order of having smaller sizes of absolute values among the plurality of elements included in the matrix. Also, in the step of obtaining a second matrix, elements in the number corresponding to the second proportion may be identified in the order of having smaller sizes of absolute values among the plurality of elements included in the retrained first matrix.

Meanwhile, the control method may further include the steps of obtaining second accuracy of an artificial intelligence model including the second matrix based on the test data, and based on the second accuracy being within the preset range with respect to the preset value, retraining the artificial intelligence model including the second matrix based on the sample data, and based on the sizes of a plurality of elements included in the retrained second matrix, obtaining a third matrix pruned by converting values of elements in the number corresponding to a third proportion, which is greater than the second proportion, to zero values.

Here, the control method may further include the steps of obtaining third accuracy of an artificial intelligence model including the third matrix based on the test data, and based on the third accuracy being outside the preset range with respect to the preset value, determining the second matrix as the final matrix of the matrix included in the artificial intelligence model.

Alternatively, the control method may further include the step of, based on the number of times of pruning applied to the third matrix being a preset number of times, determining the third matrix as the final matrix of the matrix included in the artificial intelligence model.

Meanwhile, the control method may further include the step of, based on the first accuracy being outside the preset range with respect to the preset value, converting values of elements in the number corresponding to a proportion smaller than the first proportion to zero values, based on the sizes of a plurality of elements included in the matrix, so as to obtain a re-pruned first matrix.

Also, the preset value may be obtained based on the accuracy of the artificial intelligence model including the matrix based on the test data.

Meanwhile, in the step of acquiring a first matrix, the matrix may be divided into a first sub matrix and a second sub matrix through singular value decomposition (SVD) based on a first rank value, instead of a pruning operation based on the first proportion, and the first sub matrix and the second sub matrix may be combined to obtain the first matrix. Also, in the step of acquiring a second matrix, the retrained first matrix may be divided into a third sub matrix and a fourth sub matrix through SVD based on a second rank value smaller than the first rank value, instead of a pruning operation based on the second proportion, and the third sub matrix and the fourth sub matrix may be combined to obtain the second matrix.

Here, the control method may further include the steps of obtaining second accuracy of an artificial intelligence model including the second matrix based on the test data, and based on the second accuracy being outside the preset range with respect to the preset value, determining the first sub matrix and the second sub matrix as the final matrices of the matrix included in the artificial intelligence model.

Also, the control method may further include the steps of, based on the first accuracy being outside the preset range with respect to the preset value, redividing the matrix into the first sub matrix and the second sub matrix through SVD based on a second rank value bigger than the first rank value, and combining the first sub matrix and the second sub matrix to reobtain the first matrix.

### Effect of the Invention

According to the various embodiments of the disclosure as described above, an electronic device may repetitively apply a method of reducing the data capacity of an artificial intelligence model while accuracy is maintained, and thereby maintain the performance of the artificial intelligence model, and at the same time, minimize the data capacity of the artificial intelligence model.

### BRIEF DESCRIPTION OF DRAWINGS

FIG. 1A is a block diagram illustrating a configuration of an electronic device according to an embodiment of the disclosure;

FIG. 1B is a block diagram illustrating a detailed configuration of an electronic device according to an embodiment of the disclosure;

FIG. 2A and FIG. 2B are diagrams for illustrating an artificial intelligence model according to an embodiment of the disclosure;

FIG. 3A to FIG. 3C are diagrams for illustrating a pruning operation according to an embodiment of the disclosure;

FIG. 4 illustrates a retrained first matrix according to an embodiment of the disclosure;

FIG. 5A and FIG. 5B are diagrams for illustrating an effect according to additional pruning according to various embodiments of the disclosure;

FIG. 6A and FIG. 6B are diagrams for illustrating a method of dividing a matrix through SVD according to an embodiment of the disclosure;

FIG. 7A and FIG. 7B are histograms for illustrating an effect according to an embodiment of the disclosure; and

FIG. 8 is a flow chart for illustrating a control method of an electronic device according to an embodiment of the disclosure.

### BEST MODE FOR IMPLEMENTING THE INVENTION

[symbol]

### Mode for Implementing the Invention

Hereinafter, various embodiments of the disclosure will be described in detail with reference to the accompanying drawings.

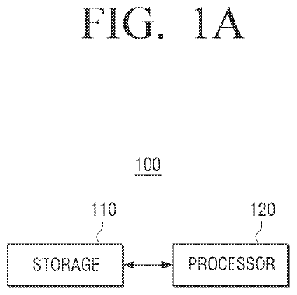

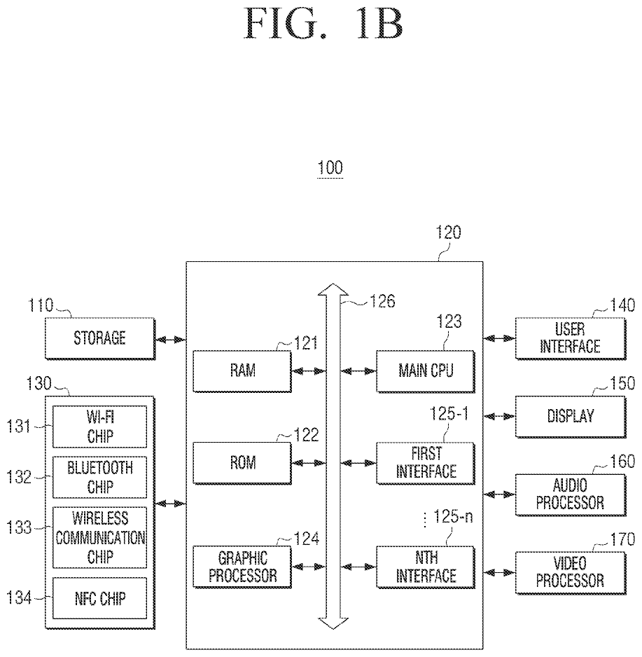

FIG. 1A is a block diagram illustrating a configuration of an electronic device 100 according to an embodiment of the disclosure. As illustrated in FIG. 1A, the electronic device 100 includes a storage 110 and a processor 120.

The electronic device 100 may be a device that reduces the data capacity of an artificial intelligence model. For example, the electronic device 100 may be a device that prunes a matrix included in an artificial intelligence model, and it may be a server, a desktop PC, a laptop computer, a smartphone, a tablet PC, etc. Alternatively, the electronic device 100 may be a device that divides a matrix included in an artificial intelligence model into a first sub matrix and a second sub matrix through singular value decomposition (SVD). Also, in an artificial intelligence model, a plurality of matrices may be included, and the electronic device 100 may prune the entire plurality of matrices or divide the matrices into a plurality of sub matrices through SVD. That is, the electronic device 100 may be any device that can reduce the data capacity of an artificial intelligence model. Here, the matrix may be a weight matrix. Hereinafter, for the convenience of explanation, each weight included in the matrix will be described as an element.

The storage 110 may be provided separately from the processor 120, and it may be implemented as a hard disk, a non-volatile memory, and a volatile memory, etc.

The storage 110 may store sample data and a matrix included in an artificial intelligence model trained on the basis of the sample data. Here, the matrix may be filter data, kernel data, etc. constituting the artificial intelligence model. Also, the storage 110 may store a plurality of matrices included in the artificial intelligence model.

Alternatively, the storage 110 may store data that can be used for the artificial intelligence model, and the processor 120 may identify the data stored in the storage 110 as a matrix.

The storage 110 may further store test data. The test data may be data for calculating the accuracy of the artificial intelligence model.

The processor 120 controls the overall operations of the electronic device 100.

According to an embodiment of the disclosure, the processor 120 may be implemented as a digital signal processor (DSP), a microprocessor, and a time controller (TCON). However, the processor 120 is not limited thereto, and it may include one or more of a central processing unit (CPU), a micro controller unit (MCU), a micro processing unit (MPU), a controller, an application processor (AP) or a communication processor (CP), and an ARM processor, or may be defined by the terms. Also, the processor 120 may be implemented as a system on chip (SoC) having a processing algorithm stored therein or large scale integration (LSI), or in the form of a field programmable gate array (FPGA).

The processor 120 may obtain a pruned first matrix by converting values of elements in the number corresponding to a first proportion to zero values on the basis of the sizes of a plurality of elements included in the matrix. For example, the processor 120 may obtain a pruned first matrix by converting values of two elements corresponding to 8% to zero values on the basis of the sizes of 25 elements included in a matrix of 5×5. Here, pruning means an operation of converting elements expected to have low contribution for accuracy in a matrix to 0. Through such an operation, reduction of data capacity is possible, but accuracy may be reduced.

The processor 120 may identify elements in the number corresponding to the first proportion in the order of having smaller sizes of absolute values among the plurality of elements included in the matrix. For example, the processor 120 may identify two elements corresponding to 8% in the order of having smaller sizes of absolute values among 25 elements included in the matrix of 5×5. For example, in case the sizes of absolute values of elements of which rows and columns are in the location of (1, 2) and the location of (3, 3) respectively are the smallest in the matrix of 5×5, the processor 120 may convert the elements in the location of (1, 2) and the location of (3, 3) to 0, and maintain the remaining values to obtain a pruned first matrix.

The processor 120 may reduce the data capacity of the matrix through an operation as above. For example, if each of 25 elements included in the matrix of 5×5 has 32 bits, 32×25=800 bits in total were needed for storing the matrix before pruning, but after pruning, the two elements of 64 bits in total become 0, and thus the matrix may be expressed by a smaller number of bits than 64 bits. In the above, the proportion of being converted from the total number of elements to zero values was described as 8% for the convenience of explanation, but this proportion may become higher to any extent. Also, as the proportion becomes higher, the matrix may be expressed by a smaller number of bits. A proportion as described above may also be referred to as a pruning rate.

Afterwards, the processor 120 may obtain the first accuracy of the artificial intelligence model including the first matrix based on test data. For example, the processor 120 may input a plurality of number images into the artificial intelligence model including the first matrix, and determine whether the output data matches the number images, and thereby obtain the first accuracy of the artificial intelligence model including the first matrix.

However, this is merely an example for obtaining accuracy, and the processor 120 may obtain accuracy of the artificial intelligence model by numerous different methods.

If the first accuracy is within a preset range with respect to a preset value, the processor 120 may retrain the artificial intelligence model including the first matrix on the basis of sample data. Here, the processor 120 may retrain the artificial intelligence model including the first matrix while including elements which became zero values by a pruning operation in the first matrix. Also, the retraining method may be the same as the training method, and the sample data used in this case may also be the same.

Also, the preset value may be obtained based on the accuracy of the artificial intelligence model including the matrix on the basis of test data. For example, the processor 120 may obtain the accuracy of the artificial intelligence model before pruning, and use the obtained accuracy as the preset value. For example, if the accuracy of the artificial intelligence model before pruning is 80%, the processor 120 may determine whether the first accuracy is within the preset range based on 80%.

However, the disclosure is not limited thereto, and the processor 120 may use a preset value that is irrelevant to the accuracy of the artificial intelligence model before pruning. For example, even if the accuracy of the artificial intelligence model before pruning is 80%, the processor 120 may determine whether the first accuracy is within the preset range based on 70%. In this case, the preset value may be a value input by a user.

The preset range may be a value input by a user. In the aforementioned example, in case the user inputs the preset range as 2%, the processor 120 may determine whether the first accuracy is within the range of 78% to 82% based on 80%.

If the first accuracy is within the preset range with respect to the preset value, there is possibility that the data capacity of the artificial intelligence model could be reduced through an additional pruning operation while maintaining the accuracy. Accordingly, the processor 120 may retrain the artificial intelligence model including the first matrix, and elements that became 0 according to retraining may become values that are not 0 again, and specific elements among elements not converted to 0 may become close to 0. Accordingly, elements converted to 0 may be changed according to an additional pruning operation that will be described below.

The processor 120 may obtain a pruned second matrix by converting values of elements in the number corresponding to a second proportion, which is greater than the first proportion, to zero values on the basis of the sizes of a plurality of elements included in the retrained first matrix.

For example, the processor 120 may obtain a pruned first matrix by converting values of four elements corresponding to 16% which is greater than 8% to zero values, on the basis of the sizes of 25 elements included in the matrix of 5×5.

Also, the processor 120 may identify elements in the number corresponding to the second proportion in the order of having smaller sizes of absolute values among the plurality of elements included in the retrained first matrix. Here, as the pruning rate increases from the first proportion to the second proportion, elements converted to 0 may increase, and in accordance thereto, the data capacity of the artificial intelligence model can be further reduced.

The processor 120 may repeat a pruning operation and a retraining operation through a method as above.

Specifically, the processor 120 may obtain the second accuracy of the artificial intelligence model including the second matrix on the basis of the test data, and if the second accuracy is within the present range with respect to the preset value, the processor 120 may retrain the artificial intelligence model including the second matrix on the basis of the sample data, and convert values of elements in the number corresponding to a third proportion, which is greater than the second proportion, to zero values on the basis of the sizes of a plurality of elements included in the retrained second matrix.

Meanwhile, the processor 120 may obtain the third accuracy of the artificial intelligence model including the third matrix on the basis of the test data, and if the third accuracy is outside the preset range with respect to the preset value, the processor 120 may determine the second matrix as the final matrix of the matrix included in the artificial intelligence model. That is, in case the accuracy is outside the allowed range, the processor 120 may determine the matrix wherein pruning was performed the last among the matrices satisfying the allowed range as the final matrix of the matrix included in the artificial intelligence model.

Alternatively, if the number of times of pruning applied to the third matrix is a predetermined number of times, the processor 120 may determine the third matrix as the final matrix of the matrix included in the artificial intelligence model.

Meanwhile, if the first accuracy is outside the preset range with respect to the preset value, the processor 120 may obtain a re-pruned first matrix by converting values of elements in the number corresponding to a proportion smaller than the first proportion to zero values on the basis of the sizes of a plurality of elements included in the matrix, and repeat the pruning operation and the retraining operation described above.

For example, the processor 120 may obtain a pruned first matrix by converting values of two elements corresponding to 8% to zero values on the basis of the sizes of 25 elements included in the matrix of 5×5, and obtain the first accuracy of the artificial intelligence model including the first matrix on the bases of test data. If the first accuracy is outside the allowed range, and additional pruning is not performed, the processor 120 may store the initially-trained artificial intelligence model as it is, and thus the data capacity cannot be reduced. Accordingly, if the first accuracy is outside the allowed range, the processor 120 may obtain a re-pruned first matrix by converting the value of one element corresponding to 4% to zero values on the basis of the sizes of 25 elements included in the matrix of 5×5.

Meanwhile, all test data used in each step as above may be the same. Accordingly, the processor 120 may objectively compare the accuracy and the preset values of each step.

Meanwhile, in the above, a matrix of 5×5 was suggested as an example for the convenience of explanation, but an actual matrix may be very big such as a form of 10000×8000.

Meanwhile, the processor 120 may divide the matrix into a first sub matrix and a second sub matrix through singular value decomposition (SVD) based on a first rank value instead of a pruning operation based on the first proportion, and combine the first sub matrix and the second sub matrix to obtain the first matrix. Also, the processor 120 may divide the retrained first matrix into a third sub matrix and a fourth sub matrix through SVD based on a second rank value smaller than the first rank value instead of a pruning operation based on the second proportion, and combine the third sub matrix and the fourth sub matrix to obtain the second matrix.

For example, the processor 120 may divide the matrix of 10000×8000 into a first sub matrix of 10000×50 and a second sub matrix of 50×8000 through SVD based on a first rank value 50 instead of a pruning operation based on the first proportion, and combine the first sub matrix and the second sub matrix to obtain the first matrix of 10000×8000. Also, the processor 120 may divide the retrained first matrix into a third sub matrix of 10000×45 and a fourth sub matrix of 45×8000 through SVD based on a second rank value 45 smaller than the first rank value 50 instead of a pruning operation based on the second proportion, and combine the third sub matrix and the fourth sub matrix to obtain the second matrix of 10000×8000.

Here, the operation of obtaining the second matrix may be an operation in case the first accuracy is within the allowed range.

Also, in case the matrix is divided into two sub matrices, the data capacity can be reduced. In the example described above, in case the matrix of 10000×8000 is divided into a first sub matrix of 10000×50 and a second sub matrix of 50×8000, the total data can be reduced from 10000×8000=80000000 to 10000×50+50×8000=900000. That is, as a rank value is smaller, the data capacity can be reduced more.

Meanwhile, SVD means decomposition of a singular value of a matrix, and because of the characteristic of SVD, the matrix before decomposition may not be restored even if two sub matrices are combined. That is, in the aforementioned example, the first matrix obtained by combining the first sub matrix and the second sub matrix may have the same form as the matrix before being divided into the first sub matrix and the second sub matrix, but there may be a change in the detailed value.

Accordingly, in the case of the artificial intelligence model including the first sub matrix and the second sub matrix generated according to SVD, its accuracy may become lower than the artificial intelligence model including the matrix before SVD. In accordance thereto, in the same manner as pruning, whether additional application of retraining and SVD will be performed may be determined according to the accuracy of the artificial intelligence model including the first sub matrix and the second sub matrix after SVD.

The processor 120 may repeat retraining and SVD in a similar manner to a pruning operation, and stop the repeating operation based on the accuracy.

Specifically, the processor 120 may obtain the second accuracy of the artificial intelligence model including the second matrix on the basis of test data, and if the second accuracy is outside the preset range with respect to the preset value, the processor 120 may determine the first sub matrix and the second sub matrix as the final matrices of the matrix included in the artificial intelligence model.

Alternatively, if the number of times of SVD applied to the second matrix is a predetermined number of times, the processor 120 may determine the third sub matrix and the fourth sub matrix as the final matrices of the matrix included in the artificial intelligence model.

Also, if the first accuracy is outside the preset range with respect to the preset value, the processor 120 may redivide the matrix into the first sub matrix and the second sub matrix through SVD based on the second rank value bigger than the first rank value, and combine the first sub matrix and the second sub matrix to reobtain the first matrix.

Meanwhile, in the above, it was described that a pruning operation and an operation according to SVD are separate operations, but the disclosure is not limited thereto. For example, the processor 120 may repeat a pruning operation and obtain a finally-pruned matrix, and repeat an operation according to SVD for the finally-pruned matrix and obtain a plurality of final sub matrices.

Alternatively, the processor 120 may alternatingly perform the pruning operation and the operation according to SVD. For example, the processor 120 may perform the pruning operation once, and perform the operation according to SVD once, and repeat these operations.

FIG. 1B is a block diagram illustrating the detailed configuration of the electronic device 100 according to an embodiment of the disclosure. According to FIG. 1B, the electronic device 100 includes a storage 110, a processor 120, a communicator 130, a user interface 140, a display 150, an audio processor 160, and a video processor 170. Among the components illustrated in FIG. 1B, regarding the parts that overlap with the components illustrated in FIG. 1A, detailed explanation will be omitted.

The processor 120 controls the overall operations of the electronic device 100 by using various kinds of programs stored in the storage 110.

Specifically, the processor 120 includes a RAM 121, a ROM 122, a main CPU 123, a graphic processor 124, first to nth interfaces 125-1 to 125-n, and a bus 126.

The RAM 121, the ROM 122, the main CPU 123, the graphic processor 124, and the first to nth interfaces 125-1 to 125-n may be connected with one another through the bus 126.

The first to nth interfaces 125-1 to 125-n are connected with the aforementioned various kinds of components. One of the interfaces may be a network interface that is connected with an external device through a network.

The main CPU 123 accesses the storage 110, and performs booting by using the O/S stored in the storage 110. Then, the main CPU 123 performs various operations by using the various kinds of programs, etc. stored in the storage 110.

In the ROM 122, a set of instructions, etc. for system booting are stored. When a turn-on instruction is input and power is supplied, the main CPU 123 copies the O/S stored in the storage 110 in the RAM 121 according to the instruction stored in the ROM 122, and boots the system by executing the O/S. When booting is completed, the main CPU 123 copies the various kinds of application programs stored in the storage 110 in the RAM 121, and performs various kinds of operations by executing the application programs copied in the RAM 121.

The graphic processor 124 generates a screen including various objects like icons, images, and texts by using an operation part (not shown) and a rendering part (not shown). The operation part (not shown) operates attribute values such as coordinate values, shapes, sizes, and colors by which each object will be displayed according to the layout of the screen based on a received control command. Also, the rendering part (not shown) generates screens in various layouts including objects, based on the attribute values operated at the operation part (not shown). The screens generated at the rendering part (not shown) are displayed in a display area of the display 150.

Meanwhile, the aforementioned operation of the processor 120 may be performed by a program stored in the storage 110.

The storage 110 stores various kinds of data such as an operating system (O/S) software module for operating the electronic device 100, an artificial intelligence module including an artificial intelligence model and an artificial intelligence model of which data capacity has been reduced, a data capacity reduction module of an artificial intelligence model, etc.

The communicator 130 is a component performing communication with various types of external devices according to various types of communication methods. The communicator 130 includes a Wi-Fi chip 131, a Bluetooth chip 132, a wireless communication chip 133, an NFC chip 134, etc. The processor 120 performs communication with various kinds of external devices by using the communicator 130.

The Wi-Fi chip 131 and the Bluetooth chip 132 perform communication by using a Wi-Fi method and a Bluetooth method, respectively. In the case of using the Wi-Fi chip 131 or the Bluetooth chip 132, various types of connection information such as an SSID or a session key is transmitted and received first, and connection of communication is performed by using the information, and various types of information can be transmitted and received thereafter. The wireless communication chip 133 refers to a chip performing communication according to various communication standards such as IEEE, zigbee, 3rd generation (3G), 3rd generation partnership project (3GPP), and long term evolution (LTE). Meanwhile, the NFC chip 134 refers to a chip that operates in a near field communication (NFC) method using a 13.56 MHz band among various RFID frequency bands such as 135 kHz, 13.56 MHz, 433 MHz, 860-960 MHz, and 2.45 GHz.

The processor 120 may receive an artificial intelligence model or a matrix included in an artificial intelligence model from an external device through the communicator 130, and store the received data in the storage 110. Alternatively, the processor 120 may train an artificial intelligence model through an artificial intelligence algorithm by itself, and store the trained artificial intelligence model in the storage 110. Here, the artificial intelligence model may include at least one matrix.

The user interface 140 receives various user interactions. Here, the user interface 140 can be implemented in various forms according to implementation examples of the electronic device 100. For example, the user interface 140 may be a button provided on the electronic device 100, a microphone receiving a user voice, a camera detecting a user motion, etc. Alternatively, in case the electronic device 100 is implemented as a touch-based electronic device, the user interface 140 may be implemented in the form of a touch screen constituting an interlayer structure with a touch pad. In this case, the user interface 140 may be used as the aforementioned display 150.

The audio processor 160 is a component performing processing for audio data. At the audio processor 160, various kinds of processing such as decoding or amplification, noise filtering, etc. for audio data may be performed.

The video processor 170 is a component performing processing for video data. At the video processor 170, various kinds of image processing such as decoding, scaling, noise filtering, frame rate conversion, resolution conversation, etc. for video data may be performed.

Through a method as above, the processor 120 may reduce the data capacity of the matrix included in the artificial intelligence model.

Hereinafter, the operation of the electronic device 100 will be described in more detail with reference to the drawings.

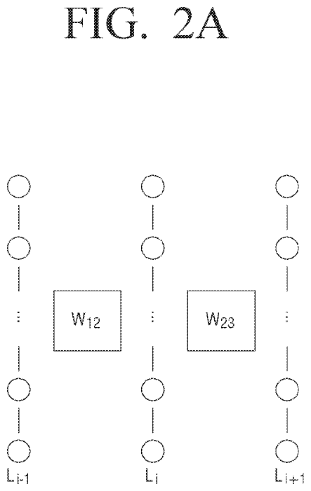

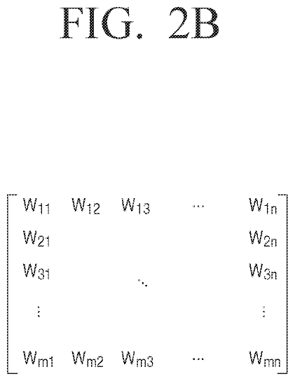

FIG. 2A and FIG. 2B are diagrams for illustrating an artificial intelligence model according to an embodiment of the disclosure.

FIG. 2A is a diagram illustrating an example of an artificial intelligence model including three layers and two matrices, and the processor 120 may obtain intermediate values of Li by inputting the input values of Li−1 into W12, and obtain a final value of Li+1 by inputting the intermediate values of Li into W23. Meanwhile, FIG. 2A illustrates an artificial intelligence model very schematically, and in actuality, an artificial intelligence model may include a lot more layers.

FIG. 2B is a diagram illustrating an example of a matrix, and a matrix may be in a form of m×n. For example, a matrix may be in a form of 10000×8000. Also, data in a matrix may have 32 bits, respectively. That is, a matrix may include 10000×8000 data having 32 bits. However, the disclosure is not limited thereto, and the size of a matrix and the bit number of each data may be different to any extent.

As illustrated in FIG. 2A and FIG. 2B, considering the size of each data included in a matrix, the number of data included in a matrix, and the number of matrices included in an artificial intelligence model, a very big storage space for storing an artificial intelligence model is needed, and a substantial amount of power may be consumed for operations of an artificial intelligence model. Accordingly, the processor 120 may secure a storage space, and reduce the amount of operations by reducing the data capacity of a matrix.

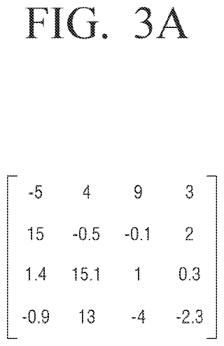

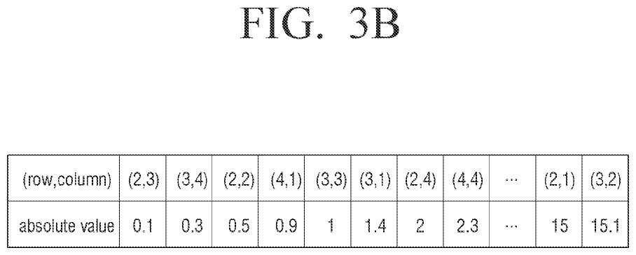

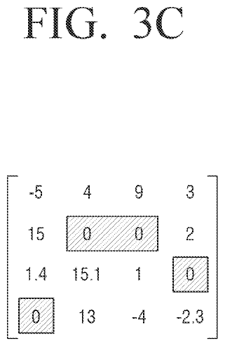

FIG. 3A to FIG. 3C are diagrams for illustrating a pruning operation according to an embodiment of the disclosure.

For the convenience of explanation, in FIG. 3A, it is explained that the matrix is in a form of 4×4.

The processor 120 may align the absolute values of the plurality of elements included in the matrix of 4×4 in FIG. 3A in the order of sizes as in FIG. 3B.

Then, the processor 120 may convert values of elements in the number corresponding to the pruning rate to zero values. For example, as illustrated in FIG. 3C, the processor 120 may obtain a pruned first matrix by converting values of four elements corresponding to the pruning rate of 25% to zero values. Here, the pruning rate may be input by a user. Alternatively, the pruning rate may be a preset value exceeding 0.

The processor 120 may obtain the first accuracy of the artificial intelligence model including the first matrix on the basis of test data. Then, the processor 120 may identify whether the first accuracy is within the preset range with respect to the preset value.

Here, the preset value may be the accuracy of the artificial intelligence model including the matrix in FIG. 3A on the basis of test data. That is, before performing a pruning operation, the processor 120 may obtain the accuracy of the artificial intelligence model including the matrix in FIG. 3A on the basis of test data. Here, all of the accuracy and the test data for calculating the first accuracy may be the same.

Also, the predetermined range may be input by a user.

If the first accuracy is within the preset range with respect to the preset value, the processor 120 may retrain the artificial intelligence model including the first matrix on the basis of sample data. That is, in case the first accuracy is maintained as a specific level after the first pruning, the processor 120 may perform retraining of the artificial intelligence model including the first matrix and additional pruning for the retrained first matrix.

Alternatively, if the first accuracy is outside the preset range with respect to the preset value, the processor 120 may obtain a re-pruned first matrix by converting values of elements in the number corresponding to a pruning rate smaller than the pruning rate to zero values on the basis of the sizes of the plurality of elements included in the matrix in FIG. 3A. That is, in case the first accuracy becomes substantially lower according to the first pruning, the processor 120 may lower the pruning rate, and perform re-pruning for securing accuracy. For example, the processor 120 may lower the pruning rate to 12.5%, and convert values of two elements to zero values to obtain a re-pruned first matrix.

After obtaining a re-pruned first matrix, the processor 120 may reacquire the first accuracy, and identify whether the first accuracy is within the preset range with respect to the preset value. Operations after that are the same as described above.

Hereinafter, retraining and additional pruning operations afterwards, in case the first accuracy is within the preset range with respect to the preset value, will be described.

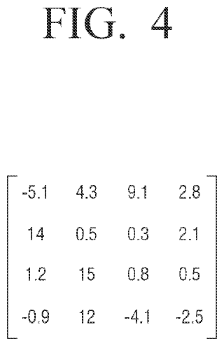

FIG. 4 illustrates a retrained first matrix according to an embodiment of the disclosure.

As illustrated in FIG. 4, the processor 120 may retrain the artificial intelligence model including the first matrix in FIG. 3C on the basis of sample data. Here, the sample data may be the same as the sample data used in training the artificial intelligence model including the matrix in FIG. 3A.

The processor 120 may use a small number of mini-batches for improvement of the processing speed in to retraining process. For example, the mini-batches may be within 10% of one epoch.

According to retraining, zero values may be changed to specific numerical values again, and the numerical values of the remaining values other than the zero values may also be changed.

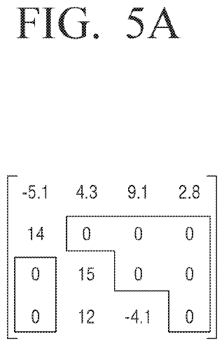

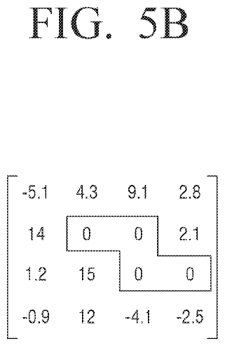

FIG. 5A and FIG. 5B are diagrams for illustrating an effect according to additional pruning according to various embodiments of the disclosure.

First, as illustrated in FIG. 5A, the processor 120 may obtain a pruned second matrix by converting values of eight elements corresponding to a pruning rate of 50% higher than 25% to zero values. In this case, elements that were not converted to zero values in FIG. 3C may also be additionally changed to zero values.

Meanwhile, in FIG. 5A, the pruning rate was abruptly increased for the convenience of explanation, but in actuality, the pruning rate may be increased more gradually.

That is, the processor 120 may increase the pruning rate from 25% to 26%. As 26% of the number of the plurality of elements included in the matrix is 4.16, the processor 120 may round off 4.16, and convert four elements to zero values. For example, as illustrated in FIG. 5B, the processor 120 may obtain a second matrix pruned for the second time. However, the disclosure is not limited thereto, and the processor 120 may determine the number of elements to be converted to zero values by performing rounding-up or rounding-down.

In the second matrix in FIG. 5B, elements in the same number compared to the first matrix in FIG. 3C were converted to zero values, but the locations of the converted elements may be changed. That is, as pruning is additionally performed by including elements converted to zero values, the probability that elements exerting less influence on the accuracy are converted to zero values may increase. That is, as elements that are relatively unnecessary are converted to zero values, the data capacity of the artificial intelligence model can be reduced without changing the accuracy greatly.

As illustrated in FIG. 3C, the processor 120 may obtain the second accuracy of the second matrix, and identify whether the second accuracy is within the preset range with respect to the preset value. Here, the method of obtaining the second accuracy and the preset range with respect to the preset value may be identical to those in FIG. 3C.

If the second accuracy is within the preset range with respect to the preset value, the processor 120 may perform retraining of the artificial intelligence model including the second matrix and additional pruning for the retrained second matrix, and such operations are the same as described in FIG. 4 to FIG. 5B.

Alternatively, if the second accuracy is outside the preset range with respect to the preset value, the processor 120 may determine the first matrix as the final matrix of the matrix included in the artificial intelligence model. That is, as the accuracy of the second matrix falls short of the standard, the processor 120 may determine the first matrix that suits the standard for accuracy as the final matrix. Also, as the first matrix is not retrained yet, it may be in a state wherein some elements have been changed to zero values, and the data capacity has been reduced.

However, the disclosure is not limited thereto, and the processor 120 may re-prune the retrained first matrix. The pruning rate used in re-pruning may be a value between the pruning rate used in pruning of the matrix and the pruning rate used in the first matrix retrained just before. For example, if the pruning rate used in pruning of the matrix is 30%, and the pruning rate used in the first matrix retrained just before is 40%, the pruning rate to be used in re-pruning of the retrained first matrix may be 35%. If the second accuracy of the artificial intelligence model including the second matrix obtained according to re-pruning of the retrained first matrix suits the standard, the accuracy can be maintained while the data capacity is reduced more than the first matrix.

In the above, it was described that a pruning operation is stopped when the accuracy does not suit the standard, but the disclosure is not limited thereto. For example, the processor 120 may end the repeated pruning operation as above on the basis of the number of times of pruning. Alternatively, the processor 120 may end the pruning operation if the data capacity of the matrix becomes smaller than the target data capacity.

As a pruning operation is repeated as above, the data capacity of the artificial intelligence model can be reduced while the accuracy of the artificial intelligence model is maintained.

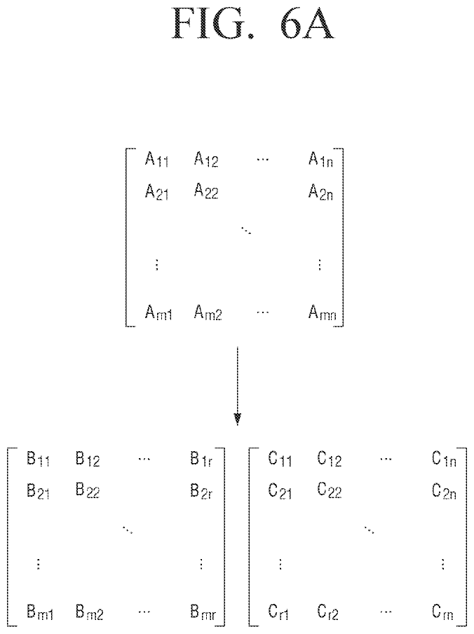

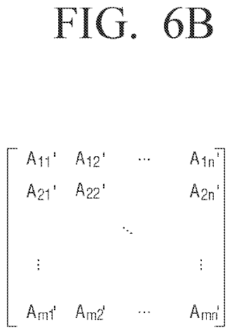

FIG. 6A and FIG. 6B are diagrams for illustrating a method of dividing a matrix through SVD according to an embodiment of the disclosure.

The upper part of FIG. 6A illustrates a matrix of m×n included in the artificial intelligence model, and as illustrated in the lower part of FIG. 6A, the processor 120 may divide the matrix of m×n into a first sub matrix of m×r and a second sub matrix of r×n through SVD based on a first rank value. That is, the processor 120 may reduce the data capacity according to dividing the matrix of m×n into a first sub matrix of m×r and a second sub matrix of r×n, and perform compression based on low-rank factorization.

Here, the first rank value may be input by a user, and as the first rank value is smaller, the data capacity may be smaller. Meanwhile, if the first rank value becomes smaller, the accuracy may become lower. Accordingly, there is a need for setting an appropriate rank value for reducing the data capacity while maintaining the accuracy.

The processor 120 may obtain a matrix of m×n as in FIG. 6B by multiplying the first submatrix of m×r and the second sub matrix of r×n in the lower part of FIG. 6A. Meanwhile, the matrix of m×n obtained in this case may have a slight difference from the matrix of m×n before being divided into a plurality of sub matrices.

That is, in general, a device having an insufficient storage space may store the first submatrix of m×r and the second sub matrix of r×n in the lower part of FIG. 6A, and perform a necessary operation by multiplying the first sub matrix and the second sub matrix depending on needs. Meanwhile, even if the first sub matrix and the second sub matrix are multiplied, the matrix of m×n before being divided into a plurality of sub matrices is not restored, and thus there may be a loss in the accuracy.

The processor 120 may perform the operation of FIG. 6A instead of the pruning operation among the operations described in FIG. 3A to FIG. 5B. Then, the processor 120 may obtain the accuracy of the plurality of divided sub matrices as in FIG. 6A by multiplying the plurality of sub matrices as in FIG. 6B.

That is, the processor 120 may replace the pruning operation among the operations described in FIG. 3A to FIG. 5B with the operation of FIG. 6A, and add an operation as in FIG. 6B before calculating accuracy. Then, the processor 120 may additionally divide the matrix in FIG. 6B through SVD. Here, the rank value may be changed instead of the pruning rate in FIG. 3A to FIG. 5B.

Specifically, if the first accuracy of the first sub matrix and the second sub matrix initially divided is within the preset range with respect to the preset value, the processor 120 may lower the rank value and divide the matrix in FIG. 6B into a third sub matrix and a fourth sub matrix.

Then, the processor 120 may obtain the second accuracy by multiplying the third sub matrix and the fourth sub matrix, and if the second accuracy is within the preset range with respect to the preset value, the processor 120 may repeat division of the matrix through SVD.

Alternatively, if the second accuracy is outside the preset range with respect to the preset value, the processor 120 may delete the third sub matrix and the fourth sub matrix that fall short of the standard, and determine the first sub matrix and the second sub matrix as the final matrices of the matrix included in the artificial intelligence model.

Meanwhile, if the first accuracy of the first sub matrix and the second sub matrix initially divided is outside the preset range with respect to the preset value, the processor 120 may heighten the rank value and redivide the initial matrix.

As the method of performing a repeating operation or an ending operation based on accuracy is the same as what is explained in FIG. 3A to FIG. 5B, overlapping explanation will be omitted.

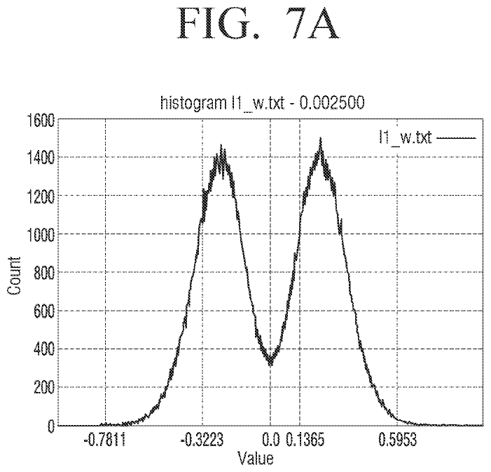

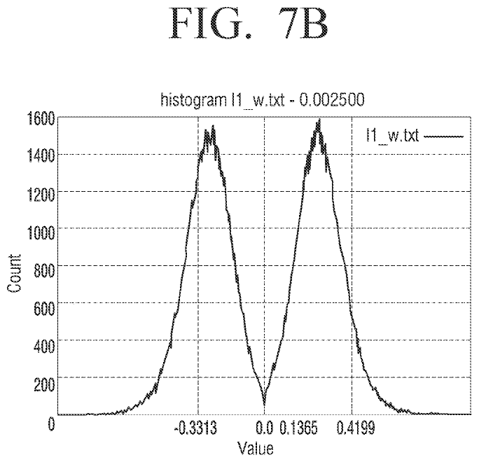

FIG. 7A and FIG. 7B are histograms for illustrating an effect according to an embodiment of the disclosure.

FIG. 7A and FIG. 7B are a result of using LeNet-5 (a caffe model) in a dataset of MNIST, and FIG. 7A indicates a histogram according to a conventional pruning method, and FIG. 7B indicates a histogram according to the pruning method of the present application, and illustrates only values excluding 0.

According to the conventional pruning method, the maximum pruning rate that can be achieved while maintaining accuracy is 91%, but according to the pruning method of the present application, the maximum pruning rate that can be achieved while maintaining accuracy is increased to 99.5%.

Also, in FIG. 7A, about 400 values that are close to 0 exist, but in FIG. 7B, there are about 100 values that are close to 0. That is, if the pruning method of the present application is used, the probability that elements exerting less influence on accuracy are changed to zero values increases, and in accordance thereto, the data capacity can be reduced. This means that elements that survived are used more efficiently.

Meanwhile, although not illustrated in FIG. 7A and FIG. 7B, in the case of using SVD, in the conventional method, an artificial intelligence model is made after performing SVD only once right after training, but according to the present application, SVD is performed repetitively, and thus accuracy can be improved. For example, if various rank values are attempted with respect to an LSTM model (a medium size) of a PTB dataset provided by Tensorflow, accuracy as below can be obtained.

[symbol]

In the case of Rank 128, the test perplexity of the conventional SVD=87.398, the test perplexity of the SVD according to the present application=84.304

In the case of Rank 64, the test perplexity of the conventional SVD=92.699, the test perplexity of the SVD according to the present application=85.297

In the case of Rank 32, the test perplexity of the conventional SVD=107.454, the test perplexity of the SVD according to the present application=88.291

[symbol]

The lower the perplexity is, the better the accuracy is, and at the same rank value, the SVD according to the present application shows higher accuracy than in the conventional method.

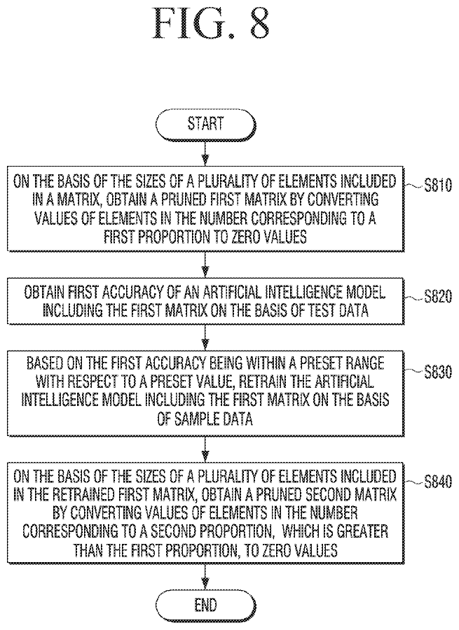

FIG. 8 is a flow chart for illustrating a control method of an electronic device according to an embodiment of the disclosure.

In a control method of an electronic device storing sample data and a matrix included in an artificial intelligence model which is trained on the basis of the sample data, first, on the basis of the sizes of a plurality of elements included in the matrix, a pruned first matrix is obtained by converting values of elements in the number corresponding to a first proportion to zero values at operation S810. Then, first accuracy of an artificial intelligence model including the first matrix is obtained on the basis of test data at operation S820. Then, if the first accuracy is within a preset range with respect to a preset value, the artificial intelligence model including the first matrix is retrained on the basis of the sample data at operation S830. Then, on the basis of the sizes of a plurality of elements included in the retrained first matrix, a pruned second matrix is obtained by converting values of elements in the number corresponding to a second proportion, which is greater than the first proportion, to zero values at operation S840.

Here, at the operation S810 of acquiring a first matrix, elements in the number corresponding to the first proportion may be identified in the order of having smaller sizes of absolute values among the plurality of elements included in the matrix. Also, at the operation S840 of obtaining a second matrix, elements in the number corresponding to the second proportion may be identified in the order of having smaller sizes of absolute values among the plurality of elements included in the retrained first matrix.

Meanwhile, the control method may further include the steps of obtaining second accuracy of an artificial intelligence model including the second matrix based on the test data, and based on the second accuracy being within the preset range with respect to the preset value, retraining the artificial intelligence model including the second matrix on the basis of the sample data, and on the basis of the sizes of a plurality of elements included in the retrained second matrix, obtaining a third matrix pruned by converting values of elements in the number corresponding to a third proportion, which is greater than the second proportion, to zero values.

Here, the control method may further include the steps of obtaining third accuracy of an artificial intelligence model including the third matrix based on the test data, and based on the third accuracy being outside the preset range with respect to the preset, value, determining the second matrix as the final matrix of the matrix included in the artificial intelligence model.

Alternatively, the control method may further include the step of, based on the number of times of pruning applied to the third matrix being a preset number of times, determining the third matrix as the final matrix of the matrix included in the artificial intelligence model.

Meanwhile, the control method may further include the step of, based on the first accuracy being outside the preset range with respect to the preset value, converting values of elements in the number corresponding to a proportion smaller than the first proportion to zero values, on the basis of the sizes of a plurality of elements included in the matrix, so as to obtain a re-pruned first matrix.

Also, the preset value may be obtained based on the accuracy of the artificial intelligence model including the matrix based on the test data.

Meanwhile, at the operation S810 of acquiring a first matrix, the matrix may be divided into a first sub matrix and a second sub matrix through singular value decomposition (SVD) based on a first rank value, instead of a pruning operation based on the first proportion, and the first sub matrix and the second sub matrix may be combined to obtain the first matrix. Also, at the operation S840 of acquiring a second matrix, the retrained first matrix may be divided into a third sub matrix and a fourth sub matrix through SVD based on a second rank value smaller than the first rank value, instead of a pruning operation based on the second proportion, and the third sub matrix and the fourth sub matrix may be combined to obtain the second matrix.

Here, the control method may further include the steps of obtaining second accuracy of an artificial intelligence model including the second matrix based on the test data, and based on the second accuracy being outside the preset range with respect to the preset value, determining the first sub matrix and the second sub matrix as the final matrices of the matrix included in the artificial intelligence model.

Alternatively, the control method may further include the steps of, based on the first accuracy being outside the preset range with respect to the preset value, redividing the matrix into the first sub matrix and the second sub matrix through SVD based on a second rank value bigger than the first rank value, and combining the first sub matrix and the second sub matrix to reobtain the first matrix.

According to the various embodiments of the disclosure as described above, an electronic device may repetitively apply a method of reducing the data capacity of an artificial intelligence model while accuracy is maintained, and thereby maintain the performance of the artificial intelligence model, and at the same time, minimize the data capacity of the artificial intelligence model.

Meanwhile, in the above, it was described that one matrix included in an artificial intelligence model is used, but the method described above may be applied to each of a plurality of matrices included in an artificial intelligence model.

Meanwhile, according to an embodiment of the disclosure, the various embodiments of the disclosure described above may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the method according to the various embodiments described above may be provided while being included in a computer program product. A computer program product refers to a product, and it can be traded between a seller and a buyer. A computer program product can be distributed on-line in the form of a storage medium that is readable by machines (e.g.: a compact disc read only memory (CD-ROM)), or through an application store (e.g.: play store™). In the case of on-line distribution, at least a portion of a computer program product may be stored in a storage medium such as the server of the manufacturer, the server of the application store, and the memory of the relay server at least temporarily, or may be generated temporarily.

In addition, according to an embodiment of the disclosure, the various embodiments described above may be implemented in a recording medium that can be read by a computer or a device similar to a computer, by using software, hardware, or a combination thereof. In some cases, the embodiments described in this specification may be implemented as a processor itself. According to implementation by software, the embodiments such as processes and functions described in this specification may be implemented by separate software modules. Each of the software modules can perform one or more functions and operations described in this specification.

Meanwhile, computer instructions for performing processing operations of machines according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disc, a blue-ray disc, a USB, a memory card, a ROM and the like.

Also, each of the components according to the aforementioned various embodiments (e.g.: a module or a program) may consist of a singular object or a plurality of objects. Further, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

While preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. An electronic device comprising:
a storage in which sample data and a matrix included in an artificial intelligence model which is trained based on the sample data are stored, and
a processor configured to:
based on sizes of a plurality of elements included in the matrix, obtain a first matrix pruned by converting values of elements in the number corresponding to a first proportion to zero values,
based on test data, obtain first accuracy of an artificial intelligence model including the first matrix,
based on the first accuracy being within a preset range with respect to a preset value, retrain the artificial intelligence model including the first matrix based on the sample data, and
based on sizes of a plurality of elements included in the retrained first matrix, obtain a second matrix pruned by converting values of elements in the number corresponding to a second proportion, which is greater than the first proportion, to zero values.

2. The electronic device of claim 1,
wherein the processor is configured to:
identify elements in the number corresponding to the first proportion in the order of having smaller sizes of absolute values among the plurality of elements included in the matrix, and
identify elements in the number corresponding to the second proportion in the order of having smaller sizes of absolute values among the plurality of elements included in the retrained first matrix.

3. The electronic device of claim 1,
wherein the processor is configured to:
obtain second accuracy of an artificial intelligence model including the second matrix based on the test data,
based on the second accuracy being within the preset range with respect to the preset value, retrain the artificial intelligence model including the second matrix based on the sample data, and
based on sizes of a plurality of elements included in the retrained second matrix, obtain a third matrix pruned by converting values of elements in the number corresponding to a third proportion, which is greater than the second proportion, to zero values.

4. The electronic device of claim 3,
wherein the processor is configured to:
obtain third accuracy of an artificial intelligence model including the third matrix based on the test data, and
based on the third accuracy being outside the preset range with respect to the preset value, determine the second matrix as the final matrix of the matrix included in the artificial intelligence model.

5. The electronic device of claim 3,
wherein the processor is configured to:
based on the number of times of pruning applied to the third matrix being a preset number of times, determine the third matrix as the final matrix of the matrix included in the artificial intelligence model.

6. The electronic device of claim 1,
wherein the processor is configured to:
based on the first accuracy being outside the preset range with respect to the preset value, convert values of elements in the number corresponding to a proportion smaller than the first proportion to zero values, based on the sizes of a plurality of elements included in the matrix, so as to obtain a re-pruned first matrix.

7. The electronic device of claim 1,
wherein the preset value was obtained based on the accuracy of the artificial intelligence model including the matrix based on the test data.

8. The electronic device of claim 1,
wherein the processor is configured to:
divide the matrix into a first sub matrix and a second sub matrix through singular value decomposition (SVD) based on a first rank value, instead of a pruning operation based on the first proportion, and combine the first sub matrix and the second sub matrix to obtain the first matrix, and
divide the retrained first matrix into a third sub matrix and a fourth sub matrix through SVD based on a second rank value smaller than the first rank value, instead of a pruning operation based on the second proportion, and combine the third sub matrix and the fourth sub matrix to obtain the second matrix.

9. The electronic device of claim 8,
wherein the processor is configured to:
obtain second accuracy of an artificial intelligence model including the second matrix based on the test data, and
based on the second accuracy being outside the preset range with respect to the preset value, determine the first sub matrix and the second sub matrix as the final matrices of the matrix included in the artificial intelligence model.

10. The electronic device of claim 8,
wherein the processor configured to:
based on the first accuracy being outside the preset range with respect to the preset value, redivide the matrix into the first sub matrix and the second sub matrix through SVD based on a second rank value bigger than the first rank value, and combine the first sub matrix and the second sub matrix to reobtain the first matrix.

11. A control method of an electronic device storing sample data and a matrix included in an artificial intelligence model which is trained based on the sample data, the method comprising:
based on sizes of a plurality of elements included in the matrix, obtaining a first matrix pruned by converting values of elements in the number corresponding to a first proportion to zero values;
based on test data, obtaining first accuracy of an artificial intelligence model including the first matrix;
based on the first accuracy being within a preset range with respect to a preset value, retraining the artificial intelligence model including the first matrix based on the sample data; and
based on sizes of a plurality of elements included in the retrained first matrix, obtaining a second matrix pruned by converting values of elements in the number corresponding to a second proportion, which is greater than the first proportion, to zero values.

12. The control method of claim 11,
wherein the obtaining a first matrix comprises:
identifying elements in the number corresponding to the first proportion in the order of having smaller sizes of absolute values among the plurality of elements included in the matrix, and
the obtaining a second matrix comprises:
identifying elements in the number corresponding to the second proportion in the order of having smaller sizes of absolute values among the plurality of elements included in the retrained first matrix.

13. The control method of claim 11, further comprising:
obtaining second accuracy of an artificial intelligence model including the second matrix based on the test data;
based on the second accuracy being within the preset range with respect to the preset value, retraining the artificial intelligence model including the second matrix based on the sample data; and
based on sizes of a plurality of elements included in the retrained second matrix, obtaining a third matrix pruned by converting values of elements in the number corresponding to a third proportion, which is greater than the second proportion, to zero values.

14. The control method of claim 13, further comprising:
obtaining third accuracy of an artificial intelligence model including the third matrix based on the test data; and
based on the third accuracy being outside the preset range with respect to the preset value, determining the second matrix as the final matrix of the matrix included in the artificial intelligence model.

15. The control method of claim 13, further comprising:
based on the number of times of pruning applied to the third matrix being a preset number of times, determining the third matrix as the final matrix of the matrix included in the artificial intelligence model.
